(19) United States
(12) Patent Application Publication
(10) Pub. No.: US 2006/0254798 A1
(43) Pub. Date: Nov. 16, 2006

(54) Wiring Harness Fire Protection Device

(76) Inventor: Jim Allen Reed, Waipahu, HI (US)

Correspondence Address: THE INVENTORS NETWORK, INC., 332 ACADEMY STREET, CARNEGIE, PA, 15106, US

(21) Appl. No.: 10/908,710

(22) Filed: May 24, 2005

(51) Int. Cl. H02G 3/04

(52) U.S. Cl. 174/72 A

(57) ABSTRACT

A wiring harness fire protection device for wrapping about wiring harnesses of major aircraft components and on electrical wiring, cables and conduit of electrical systems in motor vehicles and residential and commercial buildings for providing heat, fire and mechanical protection for the wiring includes a flame resistant fabric covering in roll form and preferably composed from material or products known as NOMEX r or KEVLAR r with the protection device in roll form being wrapped around the wiring harness and cut as needed.

### FIELD OF THE INVENTION

The present invention pertains to fire protection and prevention devices, and more particularly pertains to fire protection and prevention devices for wire harnesses, cables and conduit extending along and through vehicles and structures.

### BACKGROUND OF THE INVENTION

Thermal protection of electrical wiring, cables and conduit is a vital concern in contemporary society as electrical wiring extends into and through everything from motor vehicles, aircraft, sea craft, commercial, residential, and industrial buildings to household appliances and power generation plants and facilities. It is a continuous concern to protect the electrical wiring from external heat and fire, as well as to contain any danger resulting from electrical short circuits and arcing faults, as well as preventing the cracking and chafing of the electrical wiring from contacting and rubbing against surfaces such as concrete or metal framework. In addition, there are numerous activities, such as fire lighting and racecar driver, that require reliable thermal protection for the individual, and many types of fabrics, substances and materials have been designed for such thermal protection.

Among the most widely used of all nonwoven fabrics for thermal protection are families of fabric products produced by the Dupont Company and that are known by the trade names of NOMEX r and KEVLAR r. NOMEX r and KEVLAR r fabric products have numerous applications due to their inherent, high-performance heat and flame resistant properties and their superior textile properties. In particular, NOMEX r fiber products come in both fiber and sheet forms. In addition, NOMEX r fiber products provide not only thermal protection, but are unusually lightweight—a quality highly desirable for use in the aviation industry. Thus, NOMEX r fibers are found in flaps, wing-to-body fairings, nacelles, radomes, doors, floors, ceilings, stow bins and walls of aircraft.

Particular applications of NOMEX r fiber products include use as filters, industrial coated fabrics, and electrical insulation for both paper and pressboard forms where there intrinsic dielectric strength, mechanical toughness and thermal stability provide high reliability in all situations. Demanding and aggressive environments and applications where NOMEX r fiber products are used include with transformers that operate day and night, helping engines and generators maintain their cool to thereby avoid downtime and expensive maintenance costs, and protecting firefighters and racecar drivers in and from all the dangerous environments they encounter and operate in. Thus, whether manufactured as thermal resistant protective apparel, electrical insulation, or industrial filters, NOMEX r fiber products ensure the safety of the individuals, machines and products that use and relying on it. KEVLAR r is a material best known for its use in bulletproof vests, and is manufactured from molecules of extended-chain aromatic polyamides that form liquid-crystalline solutions. These solutions are, in turn, spun into highly oriented, very strong and very stiff fibers for use in a variety of products, most notably bulletproof vests.

Despite the prevalence of NOMEX r and KEVLAR r in the market, the prior art discloses a variety of sleeves, shields, and protectors for electrical cables, wiring and circuitry.

For example, the Lalikos et al. patent (U.S. Pat. No. 4,675,221) discloses a stainless steel wire device that encompasses a hose composed of ablative particles that flake away from the hose in the presence of fire with the stainless steel wire adapted to contain the particles so that they continue to form a fire protection cover after ablation.

The Marks et al. patent (U.S. Pat. No. 5,039,828) discloses a wire harness protector having first and second members mounted, respectively, to the door and door support structure with both members having conduits for enclosing and routing the wire harness.

The McCabe et al. (U.S. Pat. No. 5,504,274) discloses a braided wire harness shield having an open weave configuration for lighter and more flexible shielding for protecting the wire harness against lightning strikes and electromagnetic interference.

The Meaney et al. patent (U.S. Pat. No. 5,976,997) discloses a lightweight, low cost, easily installable protection for structures and components relating to aircraft gas turbine engines wherein the protection includes a layer of silicone rubber sealant and a layer of woven ceramic fiber applied directly to the sealant.

The Garnett patent (U.S. Pat. No. 6,109,979) discloses an explosion proof feedthrough connector that includes an explosion proof compartment, a terminal housing and a plurality of partitions for separating the terminals to avoid sparking from adjacent terminals.

The Seo patent (U.S. Pat. No. 6,603,074 B2) discloses structure for protecting a wire harness in a corrugated tube wherein a branch line of a wire harness extends laterally from the trunk line of the wire harness and through a slit in corrugated tubing with the protecting device formed unitarily with the corrugated tubing.

Nonetheless, despite the ingenuity of the above devices, there remains a need for a wire harness fire protection device that is lightweight, easy to dispose about the wire harness, and provides reliable fire prevention capabilities in all kinds of environments.

### SUMMARY OF THE INVENTION

The present invention comprehends a wiring harness fire protection device for protecting wiring harnesses, electrical components, cables, conduit and wiring in structures ranging from aircraft and cruise ships to motor vehicles, residential, industrial and commercial dwellings and structures and power plants. The wiring harness fire protection device is composed of high temperature resistant fibers and fabrics, preferably from fiber products commonly known as NOMEX r and KEVLAR r. When placed over and about wiring harnesses and electrical wiring, such heat resistant fiber and fabric coverings provide reliable and continuous heat, fire and mechanical protection for the wiring harness and the electrical wiring.

The wiring harness fire protection device preferably comes in two forms or embodiments, both of which can be easily and quickly placed on and about the wiring harness. Moreover, the wiring harness fire protection device provides both external and internal protection in so far as the wiring is protected from external heat and flame and, should one of more wires experience a short and begin to internally burn, the protection device will protect adjacent wiring harnesses and electrical wiring. The wiring harness fire protection device in wrap or roll form can be unwrapped as needed for wrapping completely about the wiring harness and then cut off and secured at both ends by tie strings (preferably also of NOMEX r fabric), or by metal rings that serve as securement collars.

It is an objective of the present invention to provide a wiring harness fire protection device that protects the wiring harness from burning in the event of a fire.

It is another objective of the present invention to provide a wiring harness fire protection device that protects the wiring harness from abrading and chafing against metal framework and other structural components.

It is yet another objective of the present invention to provide a wiring harness fire protection device that protects major aircraft components, such as flight instrumentation, avionics, navigation, radio and communications systems, from burning and failing during a fire situation thereby providing the flight crew with time to safely land the aircraft.

It is still yet another objective of the present to provide a wiring harness fire protection device that can prevent a fire from spreading should a short occur within the electrical wiring of the wrapped wiring harness.

Still yet another objective of the present invention is to provide a wiring harness fire protection device that can be easily installed onto the wiring harness of any existing or new aircraft thereby covering the wiring harness extending from the nose to the tail of the aircraft.

Still yet a further objective of the present invention is to provide a wiring harness fire protection device that can used in conjunction with electrical cabling, wiring and conduit of electrical systems found in motor vehicles, residential and commercial buildings such as in elevators of high-rise buildings.

A still further objective of the present invention is to provide a wiring harness fire protection device that allows for a wrapping placement or a slidable placement of the protection device on and about the wiring harness.

Another objective of the present invention is to provide a wiring harness fire protection device wherein the protection device for protecting wiring harnesses that is composed of material commonly known as NOMEX r or KEVLAR r.

These and other objects, features and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the wiring harness fire protection device of the present invention illustrating the device wrapped about several runs of electrical wiring that extend through the fuselage of an airliner;

FIG. 2 is a perspective view of the wiring harness fire protection device of the present invention illustrating the process of wrapping the device about wiring extending comprising a section or segment of the wiring harness;

FIG. 3 is a perspective view of the wiring harness fire protection device of the present invention illustrating the complete wrapping of the device about wiring comprising one section or segment of the wiring harness with the ends of the device secured to the wiring harness by a metal ring;

FIG. 4 is a perspective view of the wiring harness fire protection device of the present invention illustrating the complete wrapping of the device about wiring comprising one section or segment of the wiring harness with the device secured to the wiring harness by tie strings;

### DETAILED DESCRIPTION OF THE PREFERRED EMBODIMENT

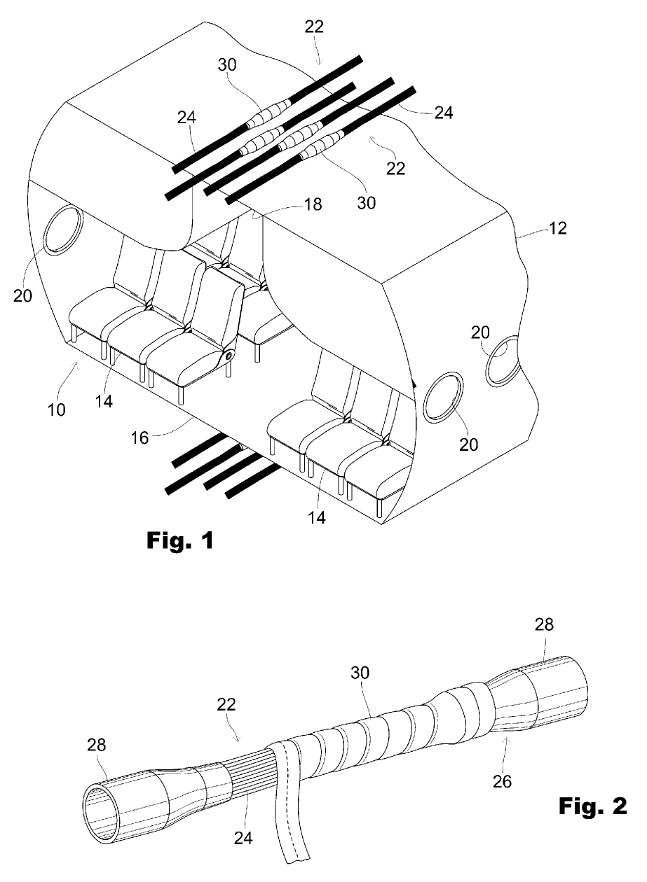

Illustrated in FIGS. 1-4 is a wiring harness fire protection device for wrapping around and encompassing wiring harnesses, electrical wiring, cabling and conduit for providing heat, fire and mechanical protection. Such wiring is found in and extends throughout electrical systems and components in everything from cruise ships, aircraft, and motor vehicles to residential, commercial and industrial structures to athletic arenas and stadiums to power plants. The wiring harness fire protection device protects the wiring from burning as a result of external fire, from abrading and chafing from contact against metal, concrete and other abrasive surfaces, and also from the danger caused by electrical short circuits and arcing faults. Thus, in using the wiring harness fire protection device of the present invention to protect aircraft components and equipment and electrical wiring in high-rise buildings, a pilot will be able to land the aircraft safely and elevators will be able to deliver passengers to safety because the wiring is protected from burning and failing during a fire condition. Thus, by way of a representative example of the use of the wiring harness fire protection device, FIG. 1 illustrates a portion of a compartment or cabin 10 of an aircraft fuselage 12 having rows of seats 14, a floor 16, a ceiling 18, portholes 20, and a plurality of wiring harnesses 22 extending along the ceiling 18 of the airline fuselage 12. For the purpose of clarity each wiring harness 22 is comprised of a number of individual electrical wires 24 bound together to form each wiring harness 22. The wiring harnesses 22 extend along the ceiling 18 and beneath the floor 16 of the aircraft fuselage 12, and are part of major aircraft components and systems such as navigation, avionics, radio and communication, and instrumentation. It is often the case that the “wiring” and “wiring harness” are interchangeably used terms; and for consistency the term “wiring harnecss” will be exclusively used for denoting the various types of electrical wiring and cables 24 found in the aforementioned machines and structures, and bundles of wires 24 that comprise the wiring harness 22. In addition, as shown in FIG. 2, wiring harnesses 22 may extend in sections or segments 26 supported at intervals by collets or collars 28.

The preferred composition or material of the wiring harness fire protection device is in the form of high temperature resistant fibers, fabrics or materials known by the trade names of NOMEX r and KEVLAR r. The thickness of the pliable, heat resistant NOMEX r or KEVLAR r fabric forming the protection device is preferably between ⅛ of an inch and one inch. As shown in FIGS. 1-4, one embodiment for the wiring harness fire protection device is in a wrap or roll configuration 30 that may be sold as rolls of various lengths and from which a length is unwound for wrapping about a section or segment 26 of the wiring harness 22. The wrap 30 can vary in length to suit the particular circumstance and environment of use. The wrap form 30 or embodiment of the protection device is tightly wrapped around the wiring harness 22 from one end of the given section 26 to the other end and then cut off by the worker. FIG. 2 shows the wrap 30 form of the protection device in the process of being wound abut the wiring harness 22 with the free end of the wrap 30 still requiring several more windings in order to completely encompass the representative section 26 of the wiring harness 22 so that all the electrical wiring 24 between the collets or collars 24 is covered.

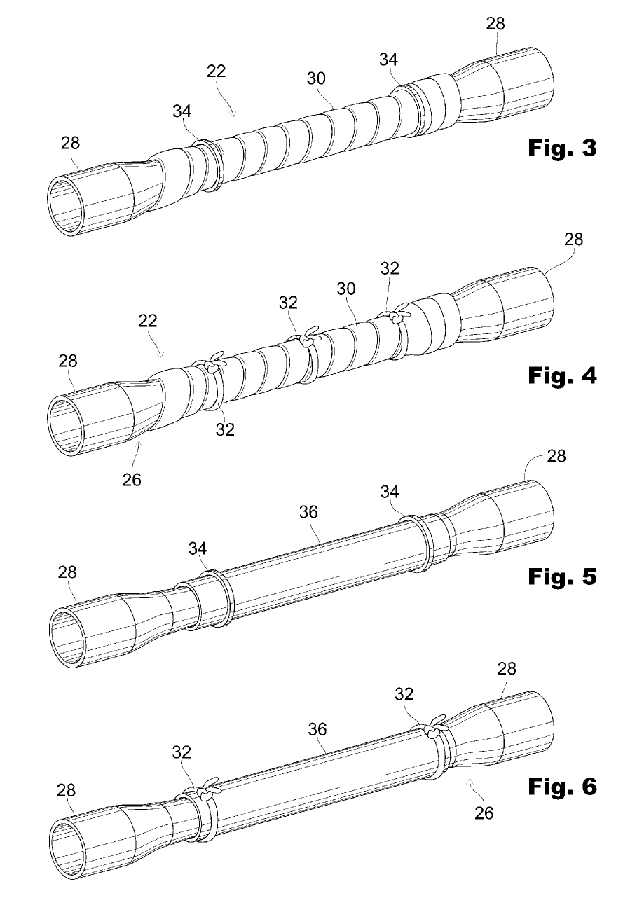

As illustrated in FIGS. 3 and 4, there are several methods for tightly securing the protection device in the form of the wrap 30 onto the wiring harness 22. In FIG. 4 the securement means includes a plurality of tie strings 32, preferably also of NOMEX r or KEVLAR r fabric, that are tied about the wrap 30 at various intervals, such as at ever three to six inches, to hold the wrap 30 in place and prevent the wrap 30 from loosening or shifting on the wiring harness 22. Shown in FIG. 3 is a second embodiment for the securement means that includes at least two metal rings or clamps 34 that are placed on the ends of the wrap 30 to hold the wrap 30 in place. The metal rings 34 can include clasps to allow for their locking about the wrap 30 and release therefrom if necessary.

Although several embodiments of the invention have been described and disclosed herein it is expected that those skilled in the art will conceive numerous alternative embodiments that will be within the spirit of the invention and the scope of the appended claims.

1. (canceled)

2. (canceled)

3. (canceled)

4. (canceled)

5. A wiring harness lire protection device for providing heat, fire and mechanical protection for a wiring harness and electrical equipment and components, comprising:
an elongated tubular-shaped member that slides upon and fits over the wiring harness for protecting the wiring harness;
the tubular-shaped member composed of a heat and flame resistant material;
the tubular-shaped member capable of being cut to the desired length to fit over and cover the wiring harness; and
means to secure the tubular-shaped member to the wiring harness so that the tubular-shaped member is securely held in place on the wiring harness,

6. The wiring harness fire protection device of claim 5 wherein the heat and flame resistant material of which the tubular-shaped member is composed is known as NOMEX r.

7. The wiring harness fire protection device of claim 6 wherein the heat and flame resistant material of which the tubular-shaped member is composed is known as KEVLAR r.

8. The wiring harness fire protection device of claim 7 wherein the means to secure the tubular-shaped member to the wiring harness includes a plurality of tie strings tied about the tubular-shaped member at regular intervals to firmly secure the tubular-shaped member to the wiring harness.

9. The wiring harness fire protection device of claim 8 wherein the means to secure the tubular-shaped member to the wiring harness includes a plurality of metal rings that can be fitted over the tubular-shaped member at regular intervals to firmly secure the tubular-shaped member to the wiring harness.

10. A wiring harness fire protection device for providing heat, fire and mechanical protection for a wiring harness and electrical equipment and components, comprising:
a length of flexible, heat resistant wrap in a roll configuration and which is capable of being unwound to the appropriate length and wrapped about a section of the wiring harness for encompassing and protecting the wiring harness;
the wrap composed of a flame and heat resistant fabric material;
a plurality of flexible tie strings that can be tied about the wrap for securing the wrap to the section of the wiring harness; and
the wrap having a thickness of between ⅛ of an inch and one inch.
